(19) United States
(12) Patent Application Publication
(10) Pub. No.: US 2015/0136849 A1
(43) Pub. Date: May 21, 2015

(54) DEVICE AND METHOD FOR WRITING A PLURALITY OF TRANSPONDERS

(71) Applicant: Checkpoint Systems, Inc., Thorofare, NJ (US)

(72) Inventors: Peter Bremer, Beerfelden (DE); Peter Schneider, Neckargemund (DE); Ralf Jakob, Wilhelmsfeld (DE)

(21) Appl. No.: 14/403,785

(22) PCT Filed: May 16, 2013
(86) PCT No.: PCT/IB2013/001857

§ 371 Date: Nov. 25, 2014

(30) Foreign Application Priority Data
May 25, 2012 (DE) 102012010252.6

(51) Int. Cl. G06K 7/10

(52) U.S. Cl. CPC G06K 7/10445; G06K 7/10465; G06K 7/10316
USPC 235/437; 235/439

(57) ABSTRACT

The present invention relates to a device and a method for writing a plurality of transponders. A rotatable member is designed to ensure a relative rotation between a load and a release device for packaging material. A reading device for reading object information during the rotation of the rotatable member is arranged on the rotatable member. Various antennae (e.g., linear polarized RFID antenna, omnidirectional antenna, dipole antenna, etc.) are provided for reading RFID's. The RFID tags are read while they rotate close to the fixed position of the RFID reading device.

The present invention relates to a device and a method for writing a plurality of transponders.

A packaging system with a rotatable member for rotating during the packaging of a load is known from EP 1 807 308 B1. The rotatable member is designed to this end to guarantee a relative rotation between the load and a release device for packaging material. A reading device for reading object information during the rotation of the rotatable member is arranged on the rotatable member. Various antennae (linear polarized RFID antenna, omnidirectional antenna, dipole antenna, etc.) are provided for reading RFID's. Reading RFID transponders using an RFID reading device is known from U.S. Pat. No. 7,336,167 B2, wherein the RFID tags are read while they rotate close to the fixed position of the RFID reading device.

The underlying object of the invention is to improve a device for a plurality of transponders as much as possible.

The problem is solved by a device having the features of independent claim 1. Advantageous developments are the subject matter of the dependent claims and contained in the description.

Accordingly, a device for writing a plurality of transponders is provided. During writing, data are transmitted to the transponders and saved on the transponders. The writing can also be designated as encoding.

The device has a region for positioning a packaging container having the plurality of transponders. The area of the region is thereby preferably larger than the footprint of the packaging container. The packaging container is for example a pallet or a carton or the like.

The device has a write-read switch. The write-read switch preferably has a send-receive switch for connecting to the transponders.

The device has an antenna device with a number of antennae. The antenna device is at least partially movable in a movement region around the region for positioning the packaging container. The antenna device is preferably moveable by means of an electromotor drive.

The device has a shield. The shield preferably has metal plates which form a shield housing. The shield is designed to shield electromagnetic waves from the antenna device while writing the plurality of transponders.

The antenna device is connected to the write-read switch for writing the plurality of transponders. The write-read switch preferably outputs an antenna signal which is radiated as electromagnetic waves from the antenna.

The region for positioning and the movement region are arranged within the shield.

A plurality of advantages is achieved by a specific development of the invention, as this is explained for example in the figures. The shield is designed to prevent writing additional transponders outside of the shield (reader-tag-collision). The shield likewise prevents interference with a further device arranged within range, which further device has a further send-receive switch and a further antenna device (reader-reader-collision). By means of the shield, which encloses the movement region of the antenna device as well as the region for positioning the packaging container, a substantially free movement of the antenna device is thus enabled for a large multitude of positions of the antenna device for as complete a detection of all transponders as possible, while at the same time effectively preventing an undesired writing of transponders outside of the shield. Thus, within the shield, a large radiation output of the antenna device can be used in order to write a plurality of transponders without having to separate the transponders. The transponders can thus be arranged in a pile in the packaging container. More than 2000 transponders in the pile can thereby be written.

The further underlying object of the invention is to provide a method for writing a plurality of transponders, which method is improved as much as possible.

This problem is solved by the method comprising the features of independent claim 10. Advantageous developments are contained in the description.

Accordingly, a method for writing a plurality of transponders is provided. During writing, data are transmitted to the transponders and saved on the transponders.

In the method, a closable opening of a shield is opened. For this purpose, a shield arrangement closing the opening is shifted into an open position.

In the method, a packaging container with a plurality of transponders is positioned through the opening into a region within the shield.

In the method, the opening is closed by a shield arrangement of a door system. The shield arrangement is for example an electrically conductive plate. The door system preferably has, for this purpose, a drive for shifting the shield arrangement.

In the method, a closed position of the shield arrangement is detected by means of a closed position sensor. The closed position sensor is designed for example as an incremental displacement sensor. A range of values for example is assigned to the closed position.

In the method, writing the plurality of transponders is started if the closed position is detected. If, in contrast, the closed position is not detected, then preferably an error message is emitted.

In the method, writing the plurality of transponders is ended, and the packaging container is removed through the opening or another opening after the ending of the writing of the plurality of transponders.

The developments described in the following relate to the device as well as to the method for writing a plurality of transponders.

It is provided in an advantageous development that the shield has at least one opening for introducing the packaging container into the region for positioning within the shield and a door system for closing the opening. The door system can be correspondingly designed as a swing door or a folding door or the like.

The door system preferably has at least one shield arrangement adjustable between an open position and a closed position. The shield arrangement is preferably designed to increase the protective damping. In the closed position, the shield arrangement preferably achieves a hermitically sealed shield for electromagnetic waves from the antenna device at least in the horizontal direction.

According to another advantageous development, the device has a control switch. The control switch is preferably connected to the write-read switch for starting and ending the writing of the plurality of transponders. The control switch preferably has yet more control functions.

The door system has especially preferably a closed position sensor, which is connected to the control switch. The closed position sensor is arranged to detect a closed position. The closed position of the shield element is thereby detectable by the shield element by means of the closed position sensor during closing of the opening of the shield.

In an advantageous development, the control switch is set up to start the writing of the plurality of transponders if the closed position of the shield arrangement is detected. If, in contrast, the closed position is not detected, then an error message is emitted.

In another development, the control switch is connected to a position sensor system. The position sensor system within the shield is aligned with the region for positioning the packaging container. The position sensor system is designed for determining the position of the packaging container in the region for positioning. The control switch is set up to emit a signal for the position of the packaging container. If, for example, the position sensor system detects a correct positioning of the packaging container in the region of positioning, then the control switch sends an associated signal to the write-read switch and the writing process is started.

In a preferred development, the write-read switch is set up for reading a plurality of transponders by means of the antenna device. This enables it to detect the number of already written transponders and the number of transponders not yet written within the shield. The write-read switch is preferably set up to continue writing the plurality of transponders until a termination criterion based on reading the plurality of transponders is satisfied. The termination criterion is preferably that the number of transponders not yet written after the movement of the antenna device along the movement region is smaller than a threshold value or for example zero.

In another development, the device has a conveyor belt for transporting the packaging container into the region of positioning. The control switch is preferably set up to emit a control signal for controlling the conveyor belt.

The shield preferably has a first opening for the input of the packaging container by means of the conveyor belt and a second opening for the output of the packaging container by means of the conveyor belt.

The control switch is set up to determine an error according to an advantageous development. The control switch is preferably set up to end the writing of the plurality of transponders after detecting the error. The control switch is preferably set up to emit error information in particular be means of an indicator. The indicator has for example a display and/or a signal light.

The previously described development variants are particularly advantageous individually as well as in combination. All development variants can thereby be combined with each other. Some possible combinations are explained in the description of the developments of the figures. These possibilities of combinations of the development variants depicted there are, however, not exhaustive.

In the following, the invention is explained in more detail through embodiments by means of graphic depictions.

As shown in

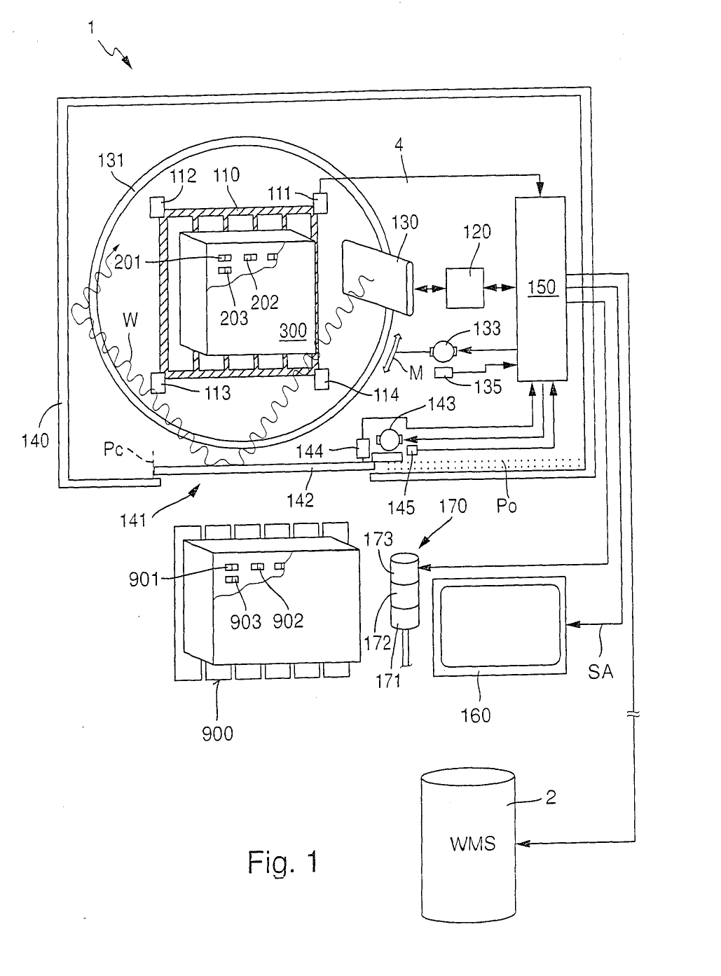

FIG. 1 a schematic view of a first embodiment of a device,

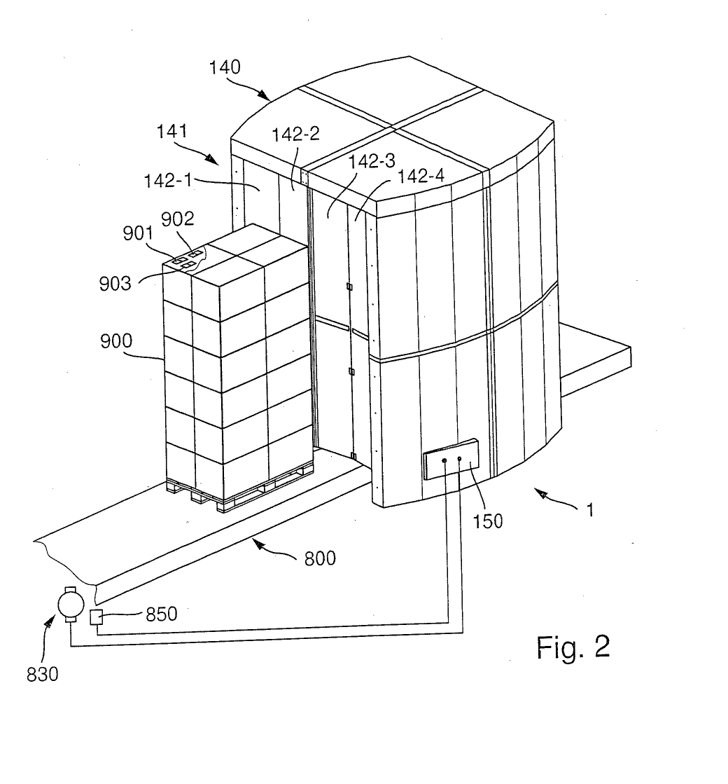

FIG. 2 a first schematic view of a second embodiment of a device,

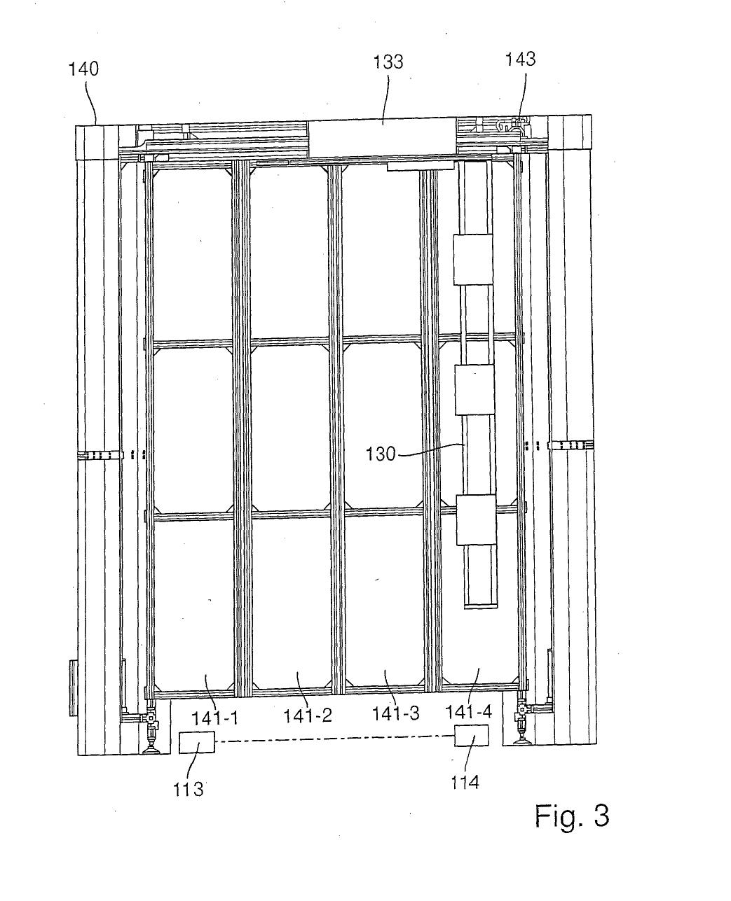

FIG. 3 a second schematic view of the second embodiment of a device,

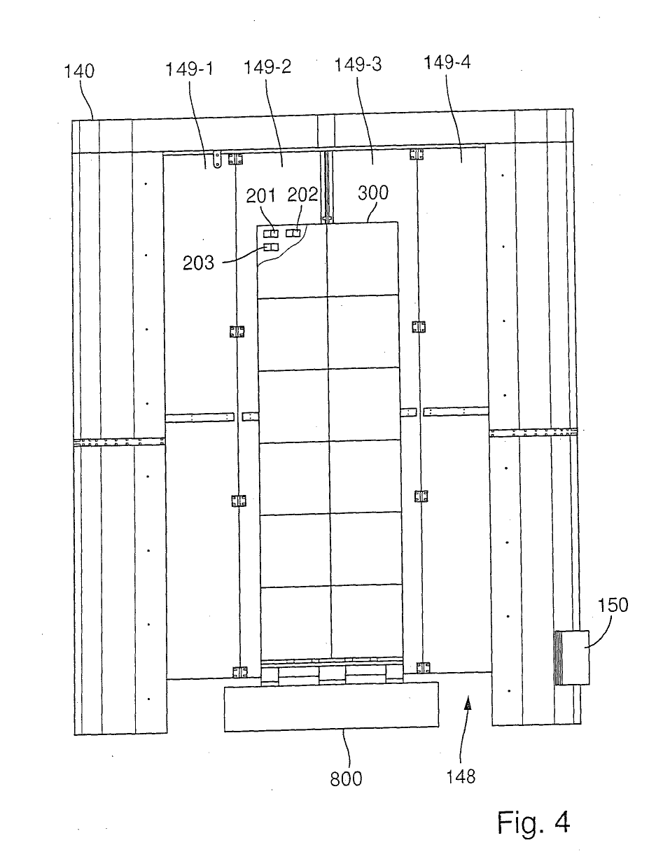

FIG. 4 a third schematic view of the second embodiment of a device,

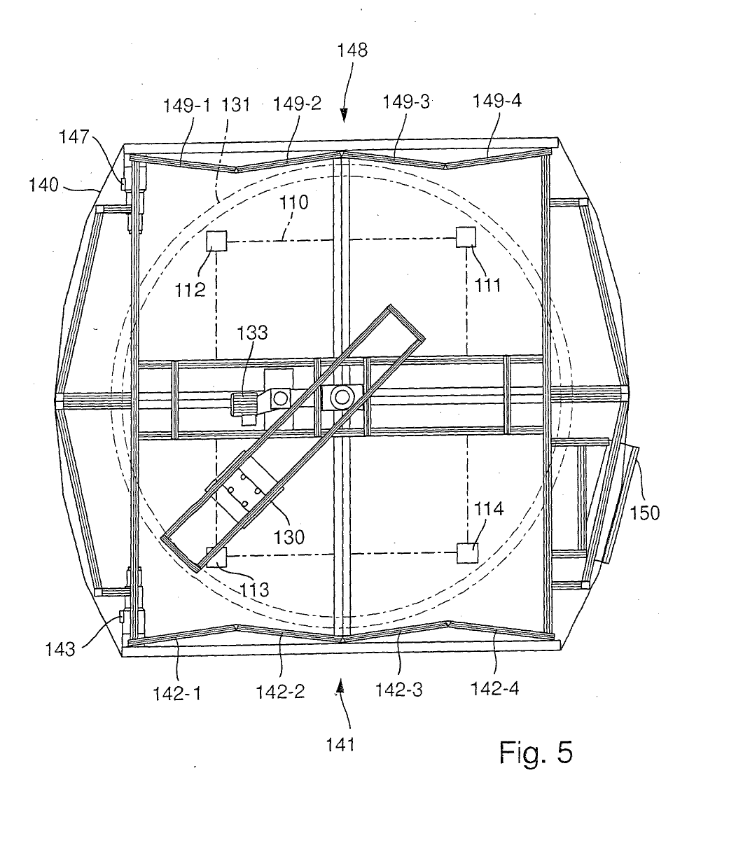

FIG. 5 a fourth schematic view of the second embodiment of a device,

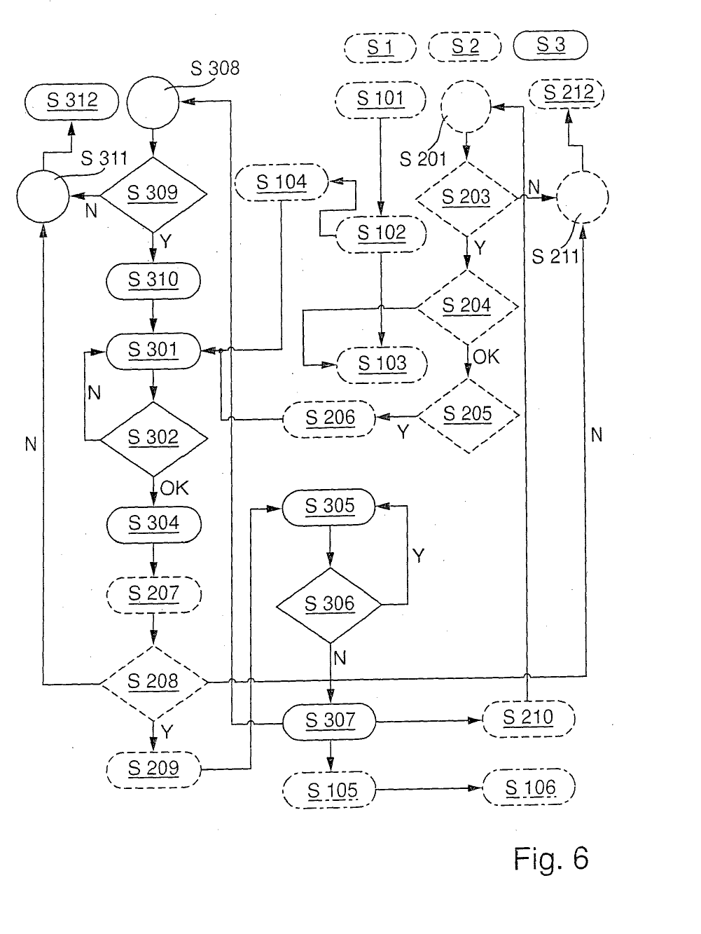

FIG. 6 a schematic flow chart.

FIG. 1 schematically depicts a device 1 for writing a plurality of transponders 210, 202, 203. The device 1 is connected to a warehouse management system (WMS) 2 via a connection, for example, a network, in order to transmit information about the written transponders 201, 202, 203 to the warehouse management system 2.

The device 1 has a shield 140, for example, comprising a metal housing. The device 1 has an indicator comprising a display 160 and comprising a signal light 170 outside of the shield 140. The signal light 170 has the signal colors green 171, yellow 172, and red 173.

A packaging container 300 is concretely depicted within the shield 140, which packaging container has a plurality of transponders 201, 202, 203, and a further packaging container 900 is outside of the shield, which packaging container has a plurality of further transponders 901, 902, 903.

The device 1 is thereby designed and set up to write a large plurality of transponders 201, 202, 203 within the shield 140. The writing can also be designated as encoding. For example, the device 1 is set up to write more than 2000 transponders 201, 202, 203 which are, for example, arranged on clothing articles in the packaging container 300. The packaging container 300 is, for example, a number of cartons on a pallet.

So that the shield 140 does not have to be lifted over the packaging container 300, the shield 140 of the embodiment of FIG. 1 has an opening 141. The opening 141 is dimensioned in such a way that the packaging container 300 is introduced through the opening 141 in a region 110 for positioning. The positioning in the region 110 is thereby monitored by means of a position sensor system comprising the sensors 111, 112, 113, 114. The sensors 111, 112, 113, 114 are, for example, optical light barriers. The position sensor system 111, 112, 113, 114 is thereby designed within the shield 140 and aligned with the region 110 for positioning. The position sensor system 111, 112, 113, 114 is connected to a control switch 150 for evaluation. The control switch 150 is set up to output a signal S_{A} to position the packaging container 300. The correct positioning is indicated, for example, by an indicator 160, 170 upon receiving the signal S_{A}.

Further, the device 1 in the embodiment of FIG. 1 has a write-read switch 120 and an antenna device 130. The antenna device 130 is thereby connected to the write-read switch 120 in order to write the plurality of transponders 201, 202, 203 in the packaging container 300 by means of electromagnetic waves W. During the writing process, the antenna device 130 is moved around the packaging container 300 along the movement region 131. The movement region 131 borders in the embodiment of FIG. 1 the region 110 for positioning the packaging container 300. For example, the antenna device 130 is rotated around a center of rotation, such that the movement M of the antenna device 130 describes a circular path around the packaging container 130 [sic: should read 300].

The antenna device 130 can, upon correct positioning of the packaging container 300 in the region 110, be moved safely around the packaging container 300 by means of a drive 133 without colliding with the packaging container 300. In the case that the packaging container 300 slips out of position during the movement of the antenna device 130, the collision is recognized by means of the sensor 135. The movement M of the antenna device 130 is interrupted in the case of a collision, in that the drive 133 of the antenna device 130 is stopped by the control switch 150 of the device 1. For example, the drive 133 of the antenna device 130 is powered in the opposite direction for a short time by the control switch 150.

The shield 140 in the embodiment of FIG. 1 has a door system comprising a motor-driven adjustable shield arrangement 142 according to the sliding door type. In FIG. 1, the opening 141 is depicted as closed by the adjustable shield arrangement 142 of the door system. The shield arrangement 142 has a conductive material, for example, a metal. In the embodiment of FIG. 1, the shield arrangement 142 is electrically conductively connected to the housing of the shield 140. The door system has a drive 143 such that by means of the drive 143, the shield arrangement 142 of the door system can be adjusted between an opened position Po and a closed position P_{C}, indicated in FIG. 1 by dots.

In the embodiment of FIG. 1, the shield 140 is designed in such a way that during the writing of the plurality of transponders 201, 202, 203, electromagnetic waves W from the antenna device 130 are shielded. An electromagnetic wave W is depicted schematically in the embodiment of FIG. 1. It is achieved by the shield 140, that a writing of further transponders 901, 902, 903 in the further packaging container 900 outside of the shield 140 is effectively prevented.

Due to reflection on the inner side of the shield 140, the electromagnetic wave W arrives back in the space within the shield 140, e.g. in the direction of the transponders 201, 202, 203. Due to reflection on the shield 140, a superposition occurs, i.e. a position-dependent strengthening or damping of the electromagnetic waves W. In order to write all transponders 201, 202, 203 as is possible, the device 1 of FIG. 1 is set up to move the antenna device 130 multiple times around the packaging material 300 by a corresponding control of the control switch 150.

Therefore, multiple advantages are achieved by the embodiment of FIG. 1. Based on the movement M of the antenna device 130, the electromagnetic waves W can reach a large number of transponders 201, 202, 203, since the electromagnetic waves W reach the transponders 201, 202, 203 in a plurality of angles. At the same time, the shield 140 prevents the undesired writing of further transponders 901, 902, 903.

To achieve as high a shield damping as possible by the shield 140 during the writing process, the control switch 150 is set up for the sequential control and check of the shield 140. For this purpose, a closed position sensor 144 of the door system is linked to the control switch 150. A signal is transmitted from the control switch 150 to the linked write-read switch 120 to start the writing process, if the closed position sensor 144 senses the closed position P_{C} of the shield arrangement 142 of the door system. The closed position sensor 144 is a limit switch in the simplest case. It is also possible to design the closed position sensor 144 as a position sensor and to determine the closed position by metering. In the ideal case, a hermetic shield is effected in the closed position Pc of the shield arrangement 142. If, in contrast, the closed position Pc is not achieved by the shield arrangement 142, for example, because a jammed object impedes the closing movement of the door system, the writing process is not started and an error signal is emitted, for example, via the indicator 160, 170. For example, the impediment of the closing movement of the door system can be determined by means of the sensor 145, wherein the sensor 145 determines a torque/torsional moment of the closing movement of the door system. For example, the sensor 145 is a current sensor, which determines the motor current of the drive 143.

The control switch 150 is connected to the write-read switch 120 in order to start and end the writing process depending on sensor signals from the sensors 111, 112, 113, 114, 135, 144, 145. The write-read switch 120 and the control switch 150 are depicted in separate blocks in FIG. 1. Alternatively, it is also possible to arrange both switches 120, 150 together in one housing. The write-read switch 120 and the control switch 150 preferably have a calculating unit (processor) for executing a program sequence (software). A program sequence is explained in more detail based on a diagram in FIG. 6.

FIG. 2 shows a first schematic view of a second embodiment of a device 1 for writing a plurality of transponders. Functionally identical units are designated by the same references as in FIG. 1. In order to move a packaging container 900 into a shield 140, a conveyor belt 800 is provided which is arranged through the shield 140. The conveyor belt 800 is driven by the drive 830. The movement of the conveyor belt 800 is sensed by the sensor 850. The conveyor belt 800 is designed to transport the packaging container 900 into the region 110 for positioning. The control switch 150 is connected to the drive 830 of the conveyor belt 800 and to the associated sensor 850. The control switch 150 is set up to emit a control signal for controlling the conveyor belt 800. The shield 140 has a first opening 141 for introduction of the packaging container 900 into the region 110 for positioning within the shield 140 by means of the conveyor belt 800.

FIG. 3 shows a second schematic view of the second embodiment of the device 1. Four shield arrangements 141-1, 141-2, 141-3, 141-4 of the door system are observed from the interior of the shield 140. The shield arrangements 141-1, 141-2, 141-3, 141-4 of the door system are designed according to folding door types. Additionally depicted is the drive 143 of the door system. The antenna device 130 has multiple antennae. At least one antenna of the antenna device 130 is arranged laterally to the packaging container. At least one antenna of the antenna device 130 is arranged over the packaging container.

The drive 133 of the antenna device 130 is arranged in the region of the cover of the shield 140. The drive 133 of the antenna device 130 enables a rotation of the antennae around the packaging container (not depicted in FIG. 3). A light barrier formed by the sensors 113, 114 enables a determination of the position of the packaging container (not depicted) in the region 110 for positioning.

FIG. 4 shows a third schematic view of the second embodiment of the device 1. Depicted is the packaging container 300 with the plurality of transponders 201, 202, 203. The packaging container 300 is positioned on the conveyor belt 800 within the shield 140. The first opening 141 (comp. FIG. 2) is not closed. In FIG. 4, the shield arrangements 149-1, 149-2, 149-3, 149-4 are visible through the first opening, which shield arrangements close a second opening 148. The shield arrangements 149-1, 149-2, 149-3, 149-4 are, for example, designed as adjustable metal shield plates. The second opening 148 of the shield 140 is designed for outputting the packaging container 300 by means of the conveyor belt 800 after the writing of the plurality of transponders 201,202, 203.

FIG. 5 shows a fourth schematic view of the second embodiment of the device 1. Depicted is a cut away view from above, wherein the cut away lies beneath the cover of the shield 140. Depicted in FIG. 5 is the antenna device 130 comprising the drive 133. The antenna device 130 is designed to move through rotation along the movement region 131. The region 110 for positioning is defined as within the movement region 131 of the antenna device 130. The positioning of the packaging container can be sensed by means of the sensors 111, 112, 113, 114.

FIG. 5 depicts that the first opening 141 for entry of the packaging container is closed by the shield arrangements 141-1, 141-2, 141-3, 141-4 and the second opening 148 is closed by the shield arrangements 149-1, 149-2, 149-3, 149-4. The shield arrangements 141-1, 141-2, 141-3, 141-4 are adjustable by the electromotor drive 143. The shield arrangements 149-1, 149-2, 149-3, 149-4 are adjustable by the electromotor drive 147.

FIG. 6 schematically depicts a process sequence for writing a plurality of transponders in the form of a diagram. The process steps for an operator or a transport device are indicated by the accentuation (dotted-dashed lines) corresponding to S1. The process steps for controlling a control software, which is executed, for example, by the control switch 150 according to FIG. 1, are indicated by the accentuation (dashed lines) corresponding to S2. The process steps for writing the transponder of a write-read software, which is executed, for example, by the write-read switch 120 according to FIG. 1, are indicated by the accentuation (solid line) corresponding to S3.

In step S101, the operator scans in the barcode of the packaging container and the device, for example by means of a hand device. In step S102, the operator transmits the information obtained by the scan to the warehouse management system and to the device. The information obtained by the scan is thereby additionally entered in step S104 into the write-read software.

The control software starts parallel in step S201. Step S203 checks whether the control switch and the write-read switch are functioning correctly. If a switch is not functioning, a critical error is determined in step 211 and in the following step S212, the yellow light of the signal light is switched on.

If, in contrast, both switches are functioning correctly, then step S204 continuously checks whether the packaging container is correctly positioned in the region of positioning. This is determined, for example, by means of sensors 111, 112, 113, 114 corresponding to FIG. 1. As long as the packaging container is not correctly positioned, the process remains in step S204. The positioning of the packaging container takes place in step S103, in that the packaging container with the plurality of transponders is positioned through an opening in a shield into the region within the shield.

Prior to step S205, the green light of a signal light is switched on to signal the correct positioning. Step S205 checks whether all safety requirements are satisfied. This type of safety requirement is, for example, the detection of a person in a hazard zone of the device. If all safety requirements are satisfied, step S206 follows, in that information about the safety requirements and the correct positioning is forwarded to the write-read software.

The write-read software begins in step S301. In step S301, the write-read software waits until, according to step S104, the information obtained by the scan is entered into the write-read software. Subsequently, step S302 checks whether, according to step S206, the information about the safety requirements and the correct positioning was forwarded to the write-read software. In step S304, the write-read software transmits a signal to the control software to enable a closing of the door system.

In step S207, the opening of the shield is closed by a shield arrangement of a door system. A closed position of the shield arrangement is thereby determined by means of a closed position sensor.

In step S208, the closed position is queried. In step S305, the writing of the plurality of transponders by means of the write-read software is thereby only started if the closed position is determined in step S208. Prior to step S305, a signal is transmitted from the control software to the write-read software in step S209, that the closed position is achieved and the antenna device is powered for movement. In addition, the yellow light of the signal light is switched on in step S209.

In step S306, the transponders within the shield are read again. If transponders that are not yet written are thereby detected, then the writing for these transponders takes place again in step S305. By means of the write-read software, the writing of the plurality of transponders is continued by means of steps S305 and S306 until a termination criterion, based on reading the plurality of transponders, is satisfied. If, for example, in step S306 no transponders are read, which have not yet been written, then this applies as a termination criterion and in step S307 the writing of the plurality of transponders is ended according to the termination of the writing process. In step S307, a signal about the termination is thereby transmitted to the control software.

The write-read software is continued in step S308. There follows a check of the status of the switches in step S309. If an error function is determined, then step S311 follows with the determination of a critical error. In the case of an error, the green light of the signal light is switched off and the red light of the signal light is switched on in step S312. If there is no error, the green light of the signal light is switched on in step S310 instead. In the following step S301, the write-read software waits again until, according to step S104, information obtained from a new scan is entered into the write-read software.

The control software is continued after step S307 by step S210. In step S210, the opening of the shield is opened again. The yellow light of the signal light is switched off and the antenna device is moved into the starting position.

After ending the writing of the plurality of transponders, corresponding information is initially output in step S105 and subsequently the packaging container is removed through the opening or a further opening in step S106. The control software, in contrast, returns to step S201.

The invention is not limited to the embodiments depicted in FIGS. 1 to 6. For example, it is possible to provide further process steps, in particular to ensure the shielding of the waves. The functionality of the device according to FIG. 1 can be used particularly advantageously for a very large number of transponders for a warehouse management system.

### LIST OF REFERENCES

1 Device

2 Database, warehouse management system

110 Region for positioning

111,112,113,114, Sensor

135, 144,145,850

120 Write-read switch

130 Antenna device

131 Movement region

133, 143, 147, 830 Drive

140 Shield

141, 148 Opening

142, 142-1, 142-2, 142-3 Shield arrangement, shield plate

142-4, 149-1, 149-2,

149-3, 149-4

150 Control switch

160 Display

170 Signal light

171 Green light

172 Yellow light

173 Red light

201,202,203,901, Transponder

902, 903

300, 900 Packaging container, pallet, carton

800 Conveyor belt

P_{C}, P_{O} Position

W Electromagnetic wave

M Movement of the antenna device

S_{A} Signal

S101 . . . S312 Process step

1. A device for writing a plurality of transponders, comprising:
a region for positioning a packaging container having a plurality of transponders;
a write-read switch;
a shield; and
an antenna device, wherein:
the antenna device is connected to the write-read switch for writing the plurality of transponders,
the antenna device is moveable in a movement region at least partially around the region for positioning, in which the region (110) for positioning and the movement region are arranged within the shield, and
the shield is designed to shield electromagnetic waves (W) from the antenna device during the writing of the plurality of transponders.

2. The device according to claim 1, wherein the shield has at least one opening for introducing the packaging container into the region for positioning within the shield and a door system for closing the opening, and in which the door system has at least one adjustable shield arrangement to increase the protective damping.

3. The device according to claim 1, further comprising a control switch (150), wherein the control switch is connected to the write-read switch for starting and ending the writing of the plurality of transponders.

4. The device according to claim 2, wherein:
the door system has a closed position sensor, which is connected to the control switch; and
the closed position sensor is arranged to detect a closed position (P_{C}) of the shield element during closing of the opening of the shield by the shield element.

5. The device according to claim 4, wherein the control switch is set up to start the writing of the plurality of transponders if the closed position (P_{C}) of the shield arrangement is detected.

6. The device according to claim 3, wherein:
the control switch is connected to a position sensor system, wherein the position sensor system is aligned with the region for positioning the packaging container and the position sensor system is designed for determining the position of the packaging container in the region for positioning; and
the control switch is set up to output a signal (S_{A}) for the position of the packaging container.

7. The device according to claim 1, wherein:
the write-read switch is set up for reading a plurality of transponders by means of the antenna device; and
the write-read switch is set up to continue writing the plurality of transponders until a termination criterion based on the reading of the plurality of transponders is satisfied.

8. The device according to claim 3, further comprising a conveyor belt for transporting the packaging container into the region for positioning, wherein:
the control switch is set up to output a control signal for controlling the conveyor belt; and
the shield has a first opening for the introduction of the packaging container by means of the conveyor belt and a second opening for the output of the packaging container by means of the conveyor belt.

9. The device (1) according to claim 3, wherein:
the control switch (150) is set up to determine an error;
the control switch (150) is set up to end the writing of the plurality of transponders (201, 202, 203) after detecting the error; and
the control switch (150) is set up to output error information in particular by means of an indicator (160, 170).

10. A method for writing a plurality of transponders, comprising:
opening an aperture of a shield;
positioning a packaging container comprising a plurality of transponders through the opening into a region within the shield;
closing the aperture by a shield arrangement of a door system;
determining a closed position (P_{C}) of the shield arrangement by means of a closed position sensor;
the plurality of transponders, when the closed position (P_{C}) is determined;
ending the writing of the plurality of transponders; and
removing, after the ending of the writing of the plurality of transponders, the packaging container through the aperture or through a further opening.
